(19) United States
(12) Patent Application Publication
(10) Pub. No.: US 2006/0019227 A1
(43) Pub. Date: Jan. 26, 2006

(54) Methods for cognitive treatment

(76) Inventor: Susan B. Hardwicke, Glen Allen, VA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 11/188,035

(22) Filed: Jul. 22, 2005

Related U.S. Application Data
(60) Provisional application No. 60/590,121, filed on Jul. 22, 2004.

(51) Int. Cl. G09B 23/28

(52) U.S. Cl. 434/262

(57) ABSTRACT

The present invention comprises methods and systems for enhancing learning skills and development of cognitive functions in humans. The methods comprise a defined set of steps or modules that include cognitive function enhancement activities such as enhancing memory and pattern recognition, and to build neuronal pathways necessary for overall cognitive improvement.

### RELATED APPLICATIONS

This application claims the priority of U.S. Provisional Patent Application No. 60/590,121, filed Jul. 22, 2004.

### FIELD OF THE INVENTION

The present invention relates to methods for enhancing learning skills and development of cognitive functions and skills in humans.

### BACKGROUND OF THE INVENTION

An estimated 4 to 5 million Americans, about 2% of all ages and 15% of those older than age 65, have some form and degree of cognitive failure. Cognitive failure, which includes dysfunction or loss of cognitive functions, the process by which knowledge is acquired, retained and used, commonly occurs in association with central nervous system (CNS) disorders or conditions, including age-associated memory impairment. Poor cognitive development, however, is often attributed to insufficient socialization and/or interaction during formative years. Cognitive dysfunction causes significant impairment of social and/or occupational functioning, which can interfere with the ability of an individual to perform activities of daily living and greatly impact the autonomy and quality of life of the individual.

Persons need training in learning skills or development of cognitive functions at many different stages of life. As a young child, the brain pathways necessary for life-long learning may not be established at an early age. For example, children who are reared in conditions where there is very little stimulation or exposure to appropriate learning conditions may not ever catch up with other age cohorts who received the stimulation needed to train their brains to learn. These children with inadequate brain pathways, through no fault of their own, are then permanently held back or never achieve the same levels of success that children who were stimulated at an early age or stimulated appropriately, can achieve. Additionally, other cognitive interfering conditions such as Attention Deficit Disorders, phobias, depression, autism, or hyperactivity may prevent a person from concentrating adequately and so those brain pathways needed for complex thinking are never fully developed. At later ages, persons may have injuries due to accidents, falls, head injuries, psychological trauma, or drug abuse that permanently change the neuronal pathways in the physical brain itself and thus harm the thinking processes of the person. With age, conditions that lead to outward signs of dementia or stress-related or hormone-related conditions may lead to loss of short-term memory, and other cognitive dysfunction for which new pathways in the brain may be needed in the brain for thinking.

Cognitive training protocols are generally employed in rehabilitating individuals who have some form and degree of cognitive dysfunction. For example, cognitive training protocols are employed in treating patients with depression or phobias to help them unlearn pathological responses associated with the depression or phobias and learn appropriate behavior. Similarly, cognitive training protocols are employed in treating patients with autism to help them unlearn pathological responses and to learn appropriate behavior. Cognitive training protocols are also employed in improving learning or performance in individuals with learning, language or reading disabilities.

Methods and systems are needed for training persons in a defined manner to enhance learning and cognitive ability.

### SUMMARY OF THE INVENTION

The present invention comprises methods and systems for enhancing cognition in humans. The methods of the present invention comprise providing cognitive training exercises, in modules, in a sequence for the person or persons undergoing the training, and measuring the cognitive gains of the person or persons. These modules comprise both mental and physical exercises designed to enhance cognition. Additionally, basic considerations for overall well-being such as rest and good nutrition are components of the methods herein. FIGS. 3A, 3B and 4 are illustrative of methods of the present invention.

### DESCRIPTION OF THE FIGURES

FIGS. 1A-D shows the major areas involved in cognitive skills, and the components of the major areas.

FIG. 2 shows an embodiment of the method steps involved in the present invention.

FIG. 3A and 3B are a schematic of an embodiment of the methods of the present invention.

FIG. 4 is an embodiment of the methods of the present invention.

### DETAILED DESCRIPTION

The present invention comprises methods and systems for enhancing learning skills and development of cognitive functions in humans. The methods and systems may comprise a defined set of steps to enhance memory and pattern recognition, and to build neuronal pathways necessary for overall cognitive ability. The methods may comprise specific sequencing of program modules for effective and rapid cognitive development.. The specific sequencing can be individually tailored in response to the level of cognition present in a person prior to application of the methods, or a general scheme can be followed in the specific sequence for a group of persons in order to enhance the general cognitive ability of the individuals in the group.

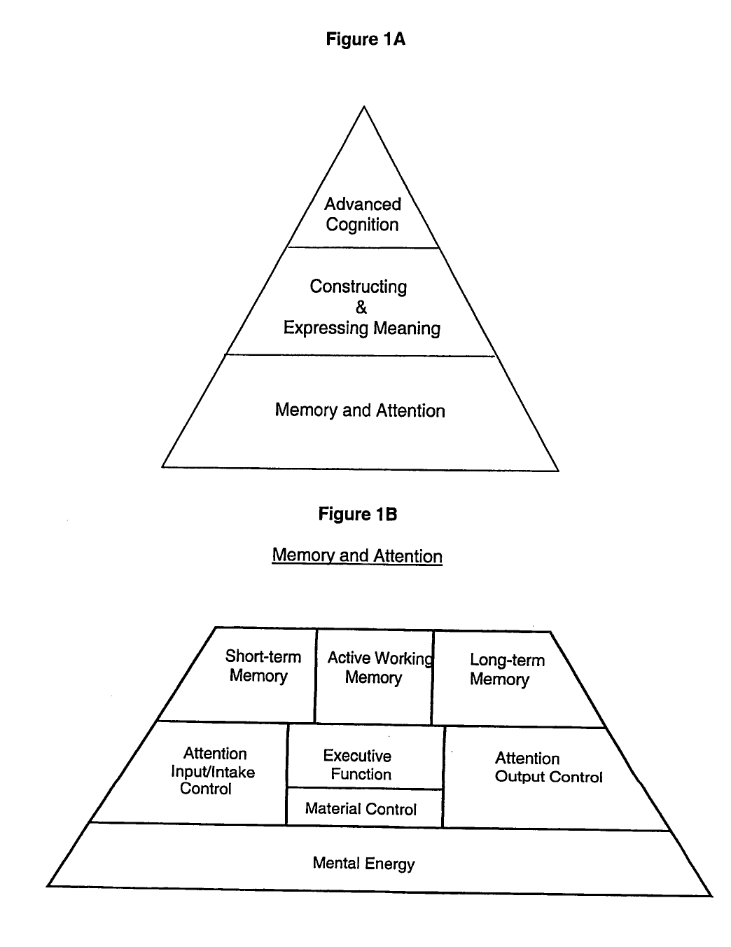

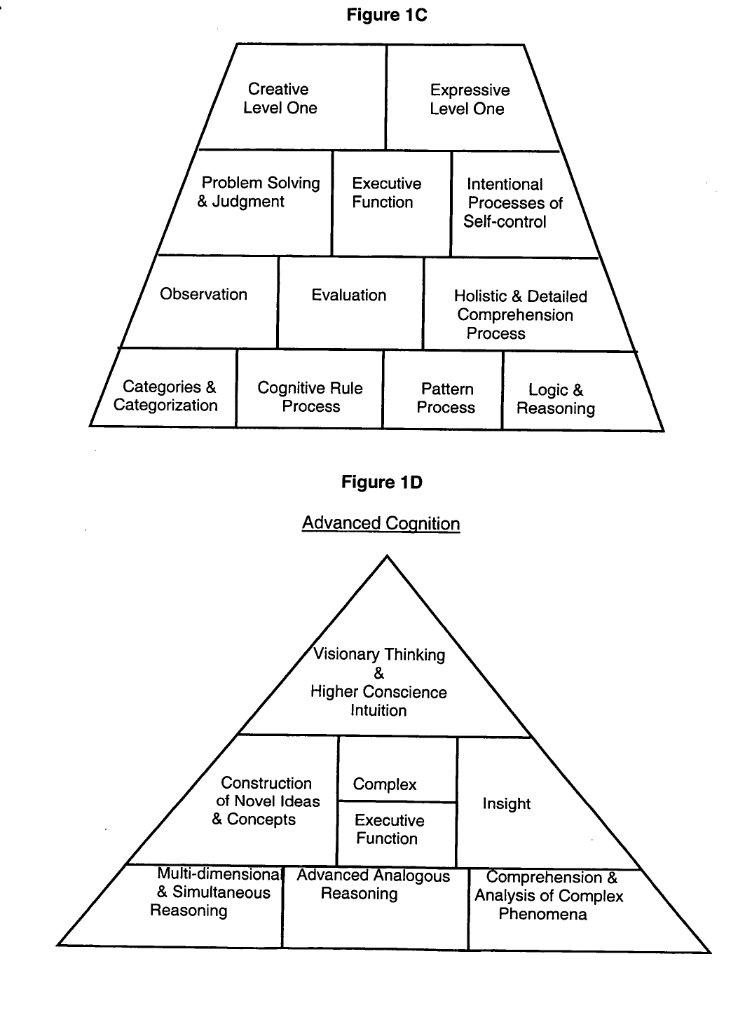

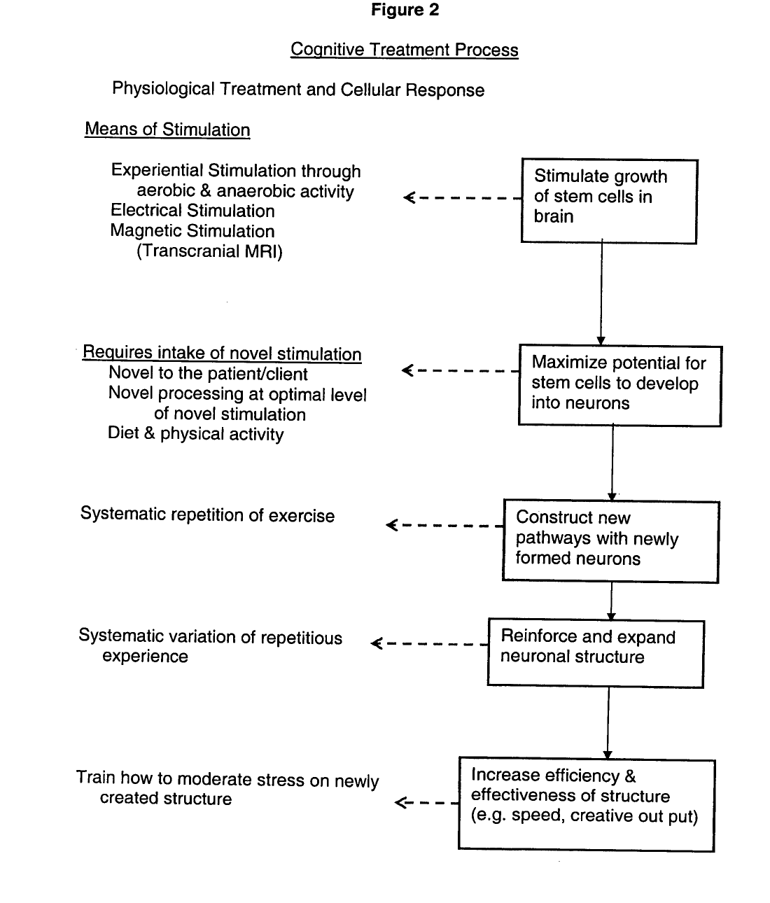

It is believed that the methods and systems of the present invention aid in creating neurons and neuronal structure and associations that are important in cognitive development and, by following the sequence of modules, these neuronal pathways are created or enhanced in function by specific learning activities alone or in combination with physical activity. As shown in FIG. 1A, there is a relationship between the cognitive skills found in humans. Memory and attention, along with mental energy are required for higher-level thinking such as constructing and expressing meaning. Thus, if the early steps in memory and attention are missing or there is a lack of mental energy, a person is inhibited, or is at least dysfunctional, in constructing and expressing meaning. The methods of the present invention comprise steps for enhancing or creating associations in the brain, referred to herein as neuronal pathways, for memory and attention, and mental energy. The degree of proficiency and complexity of the meaning of these associations that is understood by a person is dependent upon the capacity and effective functioning of memory, attention and energy. Again, if there is dysfunction at the initial steps of memory, energy and attention, there will be associated dysfunction in constructing and expressing meaning, and the person may never fully realize his or her cognitive potential. Additionally, dysfunction at the initial steps of memory, energy and attention will also result in the person never effectively participating in advanced cognition.

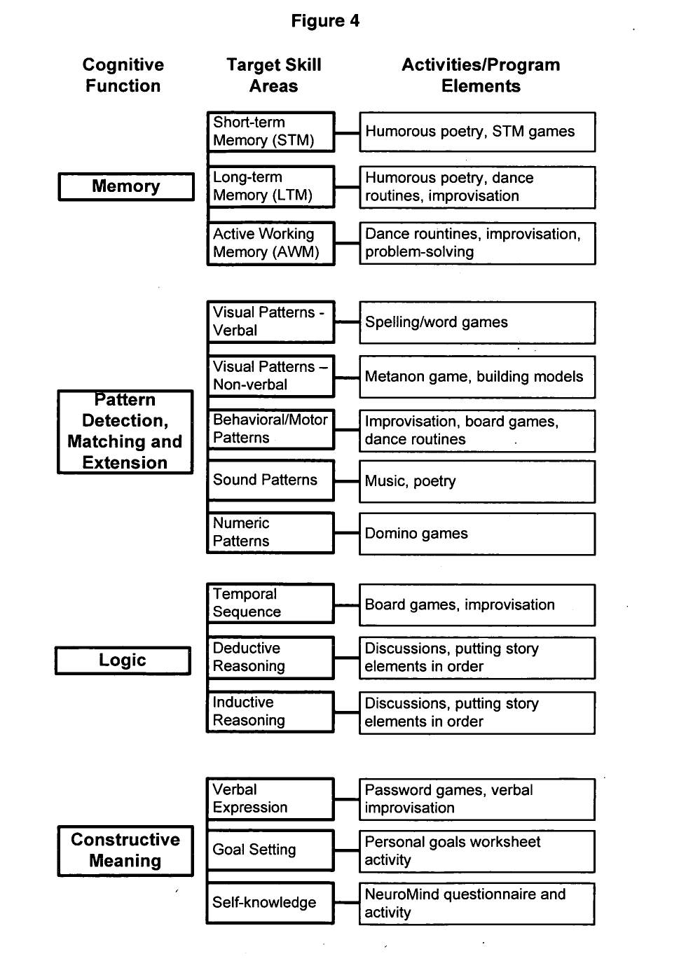

FIG. 1B shows the attributes of memory and attention that are important for the higher-level skills, as set forth in FIG. 1A. Mental energy serves as the basis for any of the steps of learning shown herein as well as for growth and development of the brain. Mental energy is dependent upon physical exercise, rest, control of stress factors, genetic make-up and good nutrition. If these basic requirements for providing mental energy to the brain are missing, there will be dysfunction in the amount of learning that can occur. Other aspects of memory, attention and energy include the self-control needed for input and intake of information and output of information. Output is indicative of memory, attention and energy, since self-control is used to pay attention to what is being presented and also to return the information back to others. Attention refers to control of inputs to the brain as well as the outputs of the brain such as behavior and thoughts. Other important aspects of this area of the basic learning steps include short-term memory, active working memory and long-term memory. Methods of the present invention include specific modules directed to improving and enhancing short-term memory, active working memory and long-term memory. Aspects of modules related to this level of learning include the ability to recognize and use facts, as well as the ability to gain and understand explicit knowledge rules. For example, as shown in FIG. 4, memory exercises or activities include, but are not limited to, reading, performing , or memorizing humorous writings, such as poetry, or performing recall exercises, of learning dance routines by seeing, practicing and performing the routines. Additionally, improvisation or performing of actions without practice is used. Improvisation of skits, songs, music, stories, games, or other activities aids in training of active working memory. Recall exercises include remembering where a particular item is found, and includes initially seeing or finding, or hearing the item, for example, a word, card, object, or tune, and the second step requires recognizing what or where the item is after it has been removed from view or hearing for a short period of time. The game Concentration, where pairs of items on one side of a deck of cards are matched from a uniformly marked set of cards is an example of a recall exercise. Modules of the present invention also comprise methods for increasing mental energy through exercise, rest, and attention to dietary intake, and exercising short term memory and long term memory.

Along with enhancing and training to improve memory attention and energy, the present invention comprises methods for enhancing, constructing and expressing meaning. Included in expressing and constructing meaning are activities such as categories and categorization, cognitive rule processing, the ability to recognize patterns, logic and reasoning, observation skills, evaluation skills and comprehension processes. Activities may be performed using computer programs that provide the activities and track the results. For example, Captain's Log, by BrainTrain, Richmond, Va., can be used. Such cognitive abilities include interpretation, translation of information, synthesis and the ability to predict, based on situations of experience or analysis to past experiences, what will happen in future similar situations. Other skills that are enhanced by the methods of the present invention include problem solving and judgment discrimination, and again, higher-level orders of self-control. Several modules of the present invention's methods include enhancement of cognitive rule processing which comprise the following steps: 1) Rule detection; 2) Rule application; 3) Rule generalization; 4) Rule differentiation; and 5) Rule extrapolation. For example, a person observes several vignettes or perform a prescribed set of activities and discovers the common requirements, which are the rules. Once the rule is detected, the rule is applied to a similar situation to test whether the rule has been correctly identified. The rule is then applied to several situations, and minor differences in the rule are discovered. The rule is then applied or used in novel situations.

The present invention comprises learning modules that enhance the portions of cognitive meaning associated with constructing and expressing meaning as shown in FIG. 1A. Such modules include, but are not limited to quantitative and qualitative measures of cognitive skills, gaming, cognitive exercises, improvisations and discussion. Structured game sequences include those directed to improving verbal skills, board games, including those directed to pattern recognition, and memorization training. Such activities can be performed individually or in small or large groups of participants.

With enhanced skills learned through the methods of the present invention, persons are then able to better participate in advanced cognition. Such advanced cognition includes multi-dimensional and simultaneous reasoning, advanced analogous reasoning and comprehension and analysis of complex phenomena. See FIG. 1D. The methods of the present invention lead to enhanced abilities to construct novel ideas and concepts, to provide insight, and to lead people to more creative and adventuresome reasoning.

Cognitive dysfunction, commonly associated with brain dysfunction and central nervous system (CNS) disorders or conditions, arises due to heredity, disease, injury and/or age. CNS disorders and conditions associated with some form and degree of cognitive failure (dysfunction) include, but are not limited to (1) age-associated memory impairment; (2) neurodegenerative disorders, such as delirium (acute confusional state); dementia, including Alzheimer's disease and non-Alzheimer's type dementias, such as, but not limited to, Lewy body dementia, vascular dementia, Binswanger's dementia (subcortical arteriosclerotic encephalopathy), dementias associated with Parkinson's disease, progressive supranuclear palsy, Huntington's disease (chorea), Pick's disease, normal-pressure hydrocephalus, Creutzfeldt-Jakob disease, Gerstmann-Strussler Scheinker disease, neurosyphilis (general paresis) or HIV infection, frontal lobe dementia syndromes, dementias associated with head trauma, including dementia pugilistica, brain trauma, subdural hematoma, brain tumor, hypothyroidism, vitamin B₁₂ deficiency, intracranial radiation; other neurodegenerative disorders; (3) psychiatric disorders, including affective disorders (mood disorders), such as, but not limited to, depression, including depressive pseudodementia; psychotic disorders, such as, but not limited to, schizophrenia and autism (Kanner's Syndrome); neurotic disorders, such as, but not limited to, anxiety and obsessive-compulsive disorder; attention deficit disorder; (4) trauma-dependent loss of cognitive function, such as, but not limited to that associated with (due to), cerebrovascular diseases, including stroke and ischemia, including ischemic stroke; brain trauma, including subdural hematoma and brain tumor; head injury; (5) disorders associated with some form and degree of cognitive dysfunction arising due to a genetic defect, such as, but not limited to, Rubinstein-Taybi syndrome and down syndrome; (6) learning, language or reading disabilities, particularly in children. By “learning disabilities” is meant disorders of the basic psychological processes that affect the way an individual learns. Learning disabilities can cause difficulties in listening, thinking, talking, reading, writing, spelling, arithmetic or combinations of any of the foregoing. Learning disabilities include, but are not limited to, perceptual handicaps, dyslexia and developmental aphasia.

The terms “cognitive performance” and “cognitive function” are art-recognized terms and are used herein in accordance with their art-accepted meanings. Cognitive functions include memory acquisition, visual discrimination, auditory discrimination, executive functioning, motor skill learning, abstract reasoning, spatial ability, speech and language skills and language acquisition. Enhancing a specific aspect of cognitive learning or performance means the ability to enhance or improve a specific cognitive or brain function, such as, for example, the acquisition of memory or the performance of a learned task. Improvement in performance of a particular cognitive task or skill means an improvement in performance of a specific cognitive task or aspect of brain function relative to performance prior to training.

Cognitive training comprises repetition of activities, and enhancements in cognitive skills are found after a period of time in which activities have been performed. For example, the period of time for enhancement of at least one cognitive skill may take from five to 100 hours, depending on the deficiencies or baseline cognitive abilities of the person. In general, cognitive training often takes between thirty and sixty hours of multiple activities that are repeated during the training time period.

The modules of the present invention provide the repeated activities that are used in the methods of enhancing and increasing learning skills. Modules comprise one or more activities, which are generally performed or accomplished in a relatively small amount of time. For example, an activity may take from a few seconds to a few minutes to start and finish, for example, from 3 seconds to 3 minutes, or longer depending on the activity. A module may comprise from 1 to 10 activities or exercises. The module is then repeated at least once a week, at least once a day or at least once every other day, and the person must perform at least one activity successfully or correctly. For example, a module is repeated at least once a week and a score of at least 50%, 60%, 70% or 80% correct responses by the person must be given for at least two measurements or assessments of the performance of at least on activity of the module. Once this rate of response is found in more than two consecutive measurements, it is determined that cognitive enhancement or learning has been established.

An embodiment of the present invention involves a method for enhancing learning skills and cognitive development comprising performing the activities of one or more modules described herein. One module comprises stimulation of the body and the mind in order to stimulate the growth of neuronal pathways, and potentially, of stem cells in the brain. Though not wishing to be bound by any particular theory, it is currently believed that stem cells in the brain develop as the result of physical exercise and form cells in the brain, such as neurons. Brain stimulation following physical exertion is expected to increase the probability that stem cells develop into neurons. Such stimulation is accomplished by aerobic and anaerobic activity such as sports or sustained physical activity, repetitive movements, electrical stimulation of the body, including the brain, and magnetic stimulation of the brain such as, but not limited to, by using transcranial magnetic resonance imaging (MRI) or SMRI. This stimulation should be new to the person so that it is a novel learning experience, both to the body and to the mind. This novel stimulation allows for the processing of neurons and for the maximum potential for stem cells of the brain to develop into neurons. The repetition of this stimulation should be systematic and regular so that the newly established connections and neural pathways established in the brain become permanent. Systematic variation of repetitious experiences leads to reinforcing and expanding the brain associations established by the neuron structures. Once the pathways are established, modules of the present invention are also used to moderate the stress on the newly-created interactions in the brain which lead to increased efficiency and effectiveness.

An embodiment of the present invention comprises performing the activities of one or more of the following modules, individually, sequentially, or in combination with one another. When used individually, the module may be used to enhance a particular level of cognitive development shown in FIG. 1A. When used in combination, each module may be combined with another module to enhance another level of cognitive development, reinforcing the individual skills developed in each level and building the interdependent skills gained from one level to another.

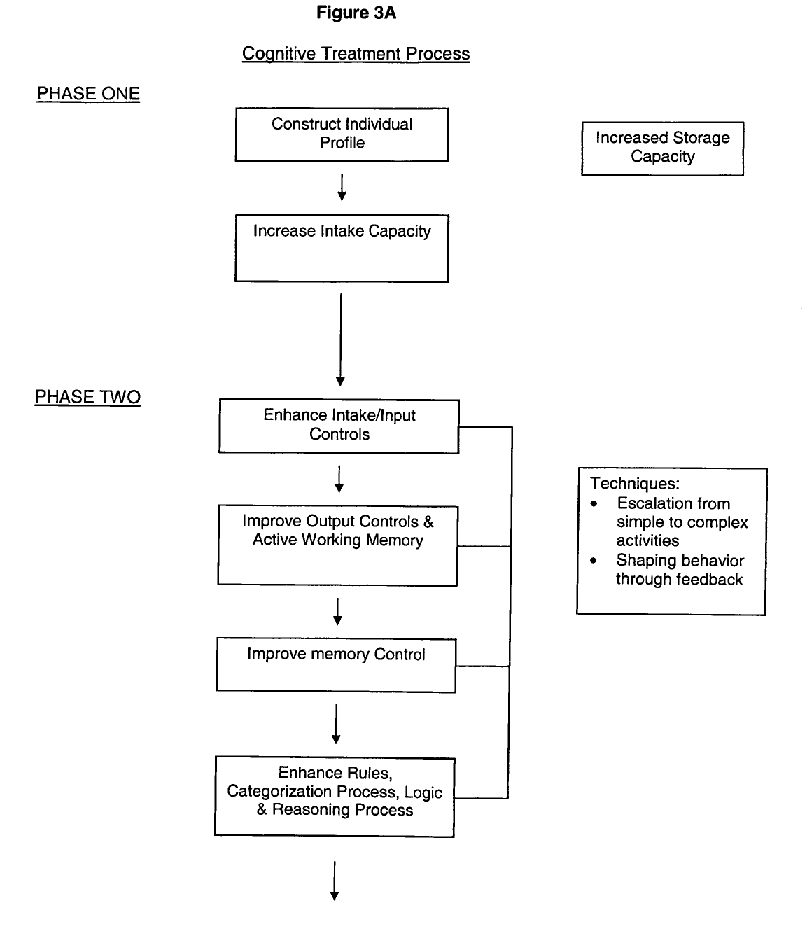

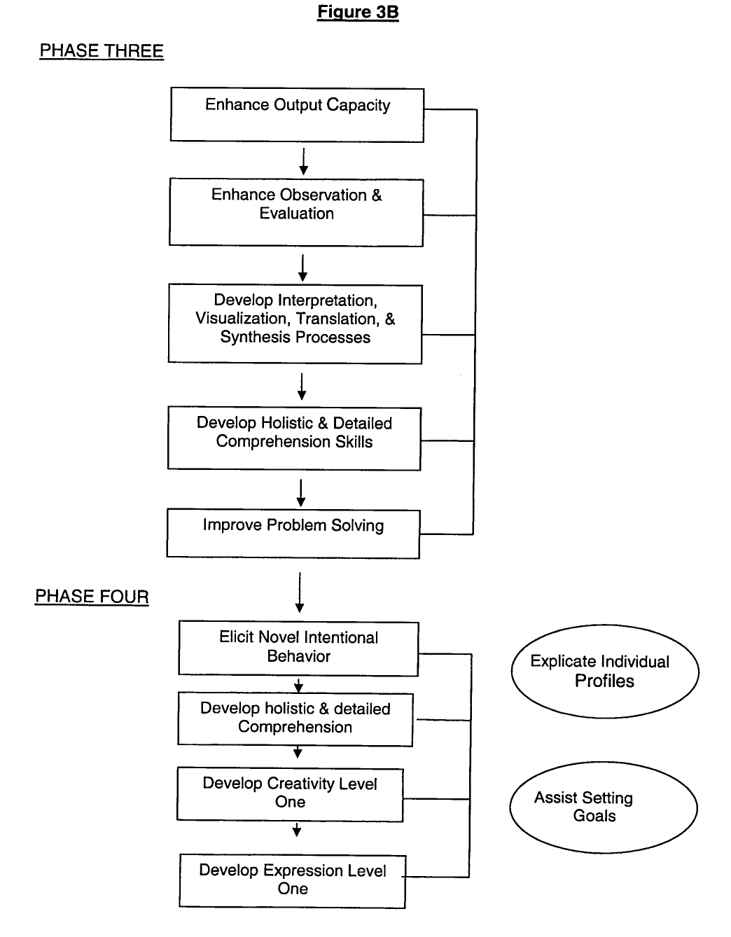

As shown in FIGS. 3A and 3B, in Phase I of treatment, a profile of the individual adult or child is constructed wherein the client is assessed for the baseline level of cognitive skills present. The cognitive skills assessed include deficiencies, for example those due to poor environmental factors such as lack of emotional, physical, or psychological stimulation, depression, or the emotional, psychological and physical side effects of chemotherapy. For example, a behavioral assessment instrument that assesses the skill levels in each of the modules shown in FIG. 1B and 1C may be used. From this individual profile, a specific sequence or number of modules is used to enhance the individual's cognitive ability based on the deficiencies identified in assessment. For example, if deficiencies are found in the skills, modules such as those shown in FIGS. 1B and 1C are then prescribed for the person. The second step of Phase I involves increasing the intake capacity of the individual with respect to these deficiencies. This involves enhancing or training the person in skills that enhance memory and attention, and activities or training that lead to improvement in mental energy. Such enhancement or training can be achieved by playing games, including board games, card games and/or electronic games, singing songs, performing dances, or by any means known in the art. These activities include performing multiple tasks to increase short-term memory such as, for example, remembering a series of numbers, being able to recall those numbers, and increasing the total number of a series of numbers that need to be remembered. Also, memory training is conducted which involves, for example, having the client view a group of articles, removing the articles, and then describing the articles once removed. Pattern recognition is an important part of the training that occurs in memory attention and energy section.

If increased memory and storage capacity are the only skills to be enhanced, Phase I may be used alone as a method to enhance those skills. If additional cognitive enhancement is desired or necessary, completion of Phase I will be followed by additional phases.

In Phase II of the training, there are modules developed to enhance intake and input controls so that the self-control and the ability to absorb the information provided is enhanced in the person. Other modules in Phase II include training that would improve output controls in active working memory, improve memory control, and enhance training in rules, categorization process, and the logic and reasoning process. The methods in this area comprise simple exercises that are escalated to complex activities so that learning is built upon, for example, recognition of simple patterns which then lead to the ability to recognize complex patterns. As with the memory enhancement techniques described above, these methods may be achieved by playing games, including board games, card games, and/or electronic games, singing songs, performing dances, or by any means known in the art.

As with Phase I, the methods of the present invention may be completed with Phase II or continue with additional phases if desired. If the assessed deficiency is limited to the ability to absorb the information provided, the method may cease with successful completion of Phase II. Upon successful completion of Phase II, however, the client may optionally be introduced to Phase III of the method of the present invention.

Phase III includes the entire order skills training for enhancing output capacity, enhancing observation and evaluation, developing the skills of interpretation, visualization, translation and synthesis processes. Other modules are directed to developing holistic and detailed comprehension skills and improving problem solving. Again, the bases for improvements in this area begin with increasing the mental energy and exercising short-term and long-term memory skills, i.e., the successful completion of Phases I and II. Modules include training exercises and assessments of changes in output capacity and observation, evaluation, and development of other skills. One method of doing this is to provide multi-sensory activities tailored for the individual such as athletics, dance, improvisation, manipulatives, board games, electronic programs, games, and the like.

As with Phases I and II, the methods of the present invention may be completed with Phase III or continue with additional phases if desired. If the assessed deficiency is limited to interpretation, visualization, translation and synthesis processes, the method may cease with successful completion of Phase III. Upon successful completion of Phase III, however, the client may optionally be introduced to Phase IV of the method of the present invention.

In Phase IV, higher-level skills are initiated, developed and enhanced. In Phase IV, modules are developed to elicit novel, intentional behaviors, further develop holistic and detailed comprehension, and develop creativity and novel expressions.

At each phase, individuals are assessed for their learning skills and if the skills are not progressing, other individual modules may be used to add to the learning. One example of assessment is the MACOE questionnaire as shown in

TABLE 1
TABLE 1

| Question | Yes | No |
|---|---|---|
| Can immediately recall a series of number of words after | | |
| hearing or seeing it once. | | |
| Can automatically reduce distraction to “stay on task” | | |
| Can easily recall age-appropriate personal data such as | | |
| address, telephone number, social security number, etc. | | |
| Can recognize places previously seen regardless of frequency | | |
| Can attend to single visual image for at least 30 seconds | | |
| Makes errors infrequently; makes few careless errors | | |
| Is alert and actively processing information (both sight | | |
| and sound) during waking hours | | |
| Does not change the subject unexpectedly on a regular basis | | |
| Monitors own work or behavior for correctness, appropriate- | | |
| ness and completeness | | |
| Can perform a series of three or more requested tasks with- | | |
| out reminders | | |

FIG. 4 shows an embodiment of the present invention wherein the area of cognition, as shown in FIG. 1A and the cognitive functions to be trained are linked to the specific activity modules of the present invention. Activities provided therein are examples for meeting the objectives of the skill sets and those skilled in the art can provide other activities designed to provide training of the particular skill sets. For example, the Metanon game, the Biocode Adventure, is available from NASCO, and provides nonverbal training for pattern recognition. Other pattern recognition activities can also be used.

In general, the present invention comprises methods and systems for enhancing cognitive ability, or increasing cognitive development comprising, providing one or more cognitive learning modules to one or more humans, wherein the one or more humans perform the activities of the cognitive learning modules. The one or more humans have an assessed deficiency or have not yet obtained a specific level of competency in cognitive development. The method may comprise acquiring skills by sequentially applying the steps shown in FIG. 3 A-B, and providing modules, such as those shown in FIG. 1 A-C, to address those skills. A module comprises directions for activities for increasing memory, attention or mental energy. Directions for increasing mental energy comprise providing appropriate physical exercise, rest, controlling stress, and good nutrition. Modules for increasing memory comprise performing tasks requiring recognizing and using facts, or gaining and understanding explicit knowledge rules. A module may comprise directions for enhancing, constructing or expressing meaning comprising directing one or more humans to perform tasks requiring recognizing categories and categorizing, processing cognitive rules, and recognizing patterns. Often, prior to providing one or more modules, assessing the cognitive deficiencies in one or more humans by completing a behavioral and cognitive skills assessment instrument, with the one or more humans.

Methods and systems of the present invention also comprise enhancing one's cognitive development, comprising, performing the activities of one or more cognitive learning modules. Modules may comprise activities for increasing memory, attention or mental energy, constructing meaning or expressing meaning, and advanced cognition. Examples of modules are shown in FIG. 1A-C. The initial cognitive abilities of the person establishes what skills need to be enhanced and thus, which modules are applied. Activities of the modules are performed by the person to enhance or increased his or her cognitive abilities.

A method for increasing cognitive development, comprises, assessing the physical and mental condition of one or more humans by gathering intake information; assessing the cognitive ability of one or more humans by completing a cognitive skills measuring instrument; determining a goal and action plan based on the results of the cognitive skills measuring instrument; providing one or modules that provide directions for activities that increase cognitive development in the area or areas where the assessment showed there was a lack or deficiency; and monitoring changes in the cognitive development of one or more humans performing the activities of the modules. A module may comprise directions for activities for increasing memory, attention or mental energy. Increasing memory comprises activities such as memorizing humorous poetry, playing short term memory games, performing dance routines, improvising dances or skits, playing spelling or word games, or building models. A module comprises directions for enhancing, constructing or expressing meaning comprising directing one or more humans to perform tasks requiring recognizing categories and categorizing, processing cognitive rules, and recognizing patterns.

The methods and system of the present invention enhance learning and cognitive development and build to the higher level cognitive skills of advanced cognition by applying the modules directed to constructing and expressing meaning and memory and attention, as shown in FIG. 1A.

It should be understood, of course, that the foregoing relates only to preferred embodiments of the present invention and that numerous modifications or alterations may be made therein without departing from the spirit and the scope of the invention as set forth in this disclosure.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

### Example 1

Three students participated in a pilot study used to determine if gaming and other non-curriculum activities could be used to enhance cognitive skills. Modules of the present invention were used such as quantitative and qualitative measures of cognitive skills, gaming, cognitive exercises, improvisations and discussion. After approximately six sessions of about 2.5 hours each, given one session per week for six weeks, three students participated and followed the sequential modules such as those shown in FIG. 4. In session 1, the assessment and individual profile was constructed. In the second week, there was a presentation of personal diagnostic charts, such as Mind Style and Personal Strengths, a structured game sequence involving verbal skills, discussions and board games directed to pattern recognition, and memorization training provided. In the third session, the pattern recognition game was played again, behavioral training was provided and verbal games were played. In session 4, there was a personal inventory and goals worksheet, dramatization practice, memorization practice, and again, pattern recognition games were played. In session 5, novel stimulations and interaction with live animals such as hamsters were used, dramatization occurred, new patterns of thinking were developed using analogy exercises and discussion, and number memorization exercises were continued.

At session 6, there was a new assessment and data collection. All of the students participating in the training had improved long-term memory, improved tendency to explore, improved ability to write, solve problems, and detect rules, and improved application. Outside observers noted that there was improvement in behavior and attitude of the students and improved grades and improved self-confidence.

### Example 2

An example of methods and systems of the present invention. Based on interpretation of research results, it has been found that improvement of cognitive functions involves intervention in three domains.
1) Physiological, which comprises activities that stimulate the generation of stem cells.
2) Psychological which comprises stimulation and repetition that increases the probability that the stem cells will evolve into neurons or supporting glial cells, and nvironmental structure and constraints that will increase the generation and utilization of inhibitory neurotransmitters.
3) Biological, which comprises the intake of enhancing nutrients and the elimination of harmful substances

Steps in the methods and systems that were performed or accomplished include,
A) performing a comprehensive “intake” of information from one or more humans undertaking the program regarding:

History of illnesses and accidents

Psychological and educational development

Academic or educational problems

Other psycho-educational evaluation findings

Diet history

Current diet

Exercise and activity history

Current exercise and activity profile

Sleep history

Current sleep habits and problems

Nutritional supplements

Current presenting problems and goals
B) Conducting an assessment of the cognitive skills using a behaviorial assessment that measures the skills of shown in FIGS. 1 B and 1 C, and constructing a cognitive profile, using the results of the assessment and the information obtained during intake for each human under treatment
C) Designing a Goal and Action Plan based on the person's cognitive profile and his or her goals and deficiencies.
D) Providing cognitive training and suggesting psychological adjustments, and also assisting the person with decisions regarding the physiological and biological adjustments needed for cognitive improvement. The person performs the activities of the modules and is assessed regularly for improvement or accomplishment of the activities.
E) measuring changes over time and monitors progress, adjusting as needed.

What is claimed is:

1. A method for enhancing cognitive ability, comprising, providing one or more cognitive learning modules to one or more humans, wherein the one or more humans perform the activities of the cognitive learning modules.

2. The method of claim 1, wherein a module comprises directions for activities for increasing memory, attention or mental energy.

3. The method of claim 2, wherein directions for increasing mental energy comprise providing appropriate physical exercise, rest, controlling stress, and good nutrition.

4. The method of claim 2, wherein increasing memory comprises performing tasks requiring recognizing and using facts, or gaining and understanding explicit knowledge rules.

5. The method of claim 1, wherein a module comprises directions for enhancing, constructing or expressing meaning comprising directing one or more humans to perform tasks requiring recognizing categories and categorizing, processing cognitive rules, and recognizing patterns.

6. The method of claim 1, further comprising, prior to providing one or more modules, assessing the cognitive deficiencies in one or more humans by completing a behavioral and cognitive skills assessment instrument with the one or more humans.

7. A method of enhancing one's cognitive development, comprising, performing the activities of one or more cognitive learning modules

8. The method of claim 7, wherein a module comprises activities for increasing memory, attention or mental energy.

9. The method of claim 8, wherein activities for increasing mental energy comprise providing appropriate physical exercise, rest, controlling stress, and eating well.

10. The method of claim 8, wherein increasing memory comprises performing tasks requiring recognizing and using facts, or gaining and understanding explicit knowledge rules.

11. The method of claim 7, wherein a module comprising enhancing, constructing or expressing meaning comprises performing tasks requiring recognizing categories and categorizing, processing cognitive rules, and recognizing patterns.

12. The method of claim 7, further comprising, prior to performing the activities of one or more modules, having an assessment of cognitive and behavioral skill levels determined by a trained assessor.

13. A method for increasing cognitive development, comprising,
a) assessing the physical and mental condition of one or more humans by gathering intake information;
b) assessing the cognitive ability of one or more humans by completing a cognitive and behavioral skill levels instrument;
c) determining a goal and action plan based on the results of the cognitive and behavioral skill levels instrument;
d) providing one or modules that provide directions for activities that increase cognitive development; and
e) monitoring, over time, changes in the cognitive development of one or more humans performing the activities of the modules.

14. The method of claim 13, wherein a module comprises directions for activities for increasing memory, attention or mental energy.

15. The method of claim 14, wherein increasing memory comprises activities such as memorizing humorous poetry, playing short term memory games, performing dance routines, improvising dances or skits, playing spelling or word games, or building models.

16. The method of claim 13, wherein a module comprises directions for enhancing, constructing or expressing meaning comprising directing one or more humans to perform tasks requiring recognizing categories and categorizing, processing cognitive rules, and recognizing patterns.
